(19) United States
(12) Patent Application Publication
(10) Pub. No.: US 2011/0231563 A1
(43) Pub. Date: Sep. 22, 2011

(54) METHOD, DEVICE, AND SYSTEM FOR INITIATING PACKET DATA NETWORK DISCONNECTION

(75) Inventors: Hong LI, Shenzhen (CN); Liang Gu, Shenzhen (CN)

(73) Assignee: TECHNOLOGIES CO., LTD., Shenzhen (CN)

(21) Appl. No.: 13/152,618

(22) Filed: Jun. 3, 2011

Related U.S. Application Data
(63) Continuation of application No. PCT/CN2009/075177, filed on Nov. 27, 2009.

(30) Foreign Application Priority Data
Dec. 4, 2008 (CN) 200810218043.1

(51) Int. Cl. G06F 15/16

(52) U.S. Cl. 709/228

(57) ABSTRACT

A method, a device, and a system for initiating Packet Data Network (PDN) disconnection are provided, so as to achieve disconnection of one or more specific PDNs. The method includes that: a Foreign Agent (FA) or a Mobile Access Gateway (MAG) receives PDN disconnection information from an authenticator; and initiates Mobile Internet Protocol (MIP) deregistration to a PDN Gateway (PDN GW) corresponding to the PDN disconnection information. The device includes a receiving module and a transmitting module. The system includes an FA or an MAG, and an authenticator connected to the FA or the MAG in a communicable manner.

### CROSS-REFERENCE TO RELATED APPLICATIONS

This application is a continuation of International Application No. PCT/CN2009/075177, filed on Nov. 27, 2009, which claims priority to Chinese Patent Application No. 200810218043.1, filed on Dec. 4, 2008, both of which are hereby incorporated by reference in their entireties.

### FIELD OF THE INVENTION

The present invention relates to the field of communications technologies, and in particular, to a method, a device, and a system for initiating Packet Data Network (PDN) disconnection.

### BACKGROUND OF THE INVENTION

The 3rd Generation Partnership Project (3GPP), the 3rd Generation Partnership Project 2 (3GPP2), and Worldwide Interoperability for Microwave Access (WiMAX) are all mainstream standards of the existing 3rd Generation (3G) communications technologies. The interworking and service sharing between the standard networks are always essential branches in technology development.

In a procedure for connecting a non-3rd Generation Partnership Project (non-3GPP) access system or a 3GPP access system to an Evolved Packet Core (EPC), a Mobile Station (MS)/User Equipment (UE) is required to establish a PDN connection with a network. A PDN corresponds to a different service providing network, and the MS/UE may be connected to different PDNs through the EPC to enjoy different services.

The inventors find that in the prior art when a network side initiates PDN disconnection, the PDN connection needs to be detached. In a case that the MS/UE is connected to multiple PDNs at the same time, the prior art can only achieve the disconnection of all PDNs associated with the MS/UE rather than the disconnection of one or more specific PDNs.

### SUMMARY OF THE INVENTION

Embodiments of the present invention provide a method, a device, and a system for initiating PDN disconnection, so as to achieve disconnection of one or more specific PDNs.

A method for initiating PDN disconnection is provided, where the method includes:

receiving, by a Foreign Agent (FA) or a Mobile Access Gateway (MAG), PDN disconnection information from an authenticator; and

initiating Mobile Internet Protocol (MIP) deregistration to a PDN Gateway (PDN GW) corresponding to the PDN disconnection information.

Another method for initiating PDN disconnection is provided, where the method includes:

receiving, by a Mobile Management Entity (MME), a Cancel Location indication from a Home Subscriber Server (HSS), in which the Cancel Location indication carries PDN disconnection information; and

transmitting a Delete Bearer Request message to a Serving Gateway (Serving GW), in which the Delete Bearer Request message carries a PDN GW address corresponding to the PDN disconnection information and a Home Address (HoA) of a Mobile Station (MS)/User Equipment (UE), so as to enable the Serving GW to initiate detachment of a corresponding General Packet Radio Service (GPRS) Tunneling Protocol (GTP) bearer to the corresponding PDN GW according to the PDN GW address and the HoA.

A device for initiating PDN disconnection is provided, where the device includes:

a receiving module, configured to receive PDN disconnection information from an authenticator; and

a transmitting module, configured to initiate MIP deregistration to a PDN GW corresponding to the PDN disconnection information according to the PDN disconnection information from the receiving module.

An auxiliary device for initiating PDN disconnection is provided, where the device includes:

a receiving module, configured to receive a Detach Indication or a Detach Info Confirm message from an Authentication, Authorization, and Accounting (AAA) server/HSS, in which the Detach Indication or the Detach Info Confirm message carries PDN disconnection information; and

a transmitting module, configured to transmit the PDN disconnection information received by the receiving module to an FA or an MAG.

An auxiliary device for initiating PDN disconnection is provided, where the device includes:

a receiving module, configured to receive a Cancel Location indication from an HSS, in which the Cancel Location indication carries PDN disconnection information; and

a transmitting module, configured to transmit a Delete Bearer Request message to a Serving GW, in which the Delete Bearer Request message carries a PDN GW address corresponding to the PDN disconnection information received by the receiving module and a HoA of an MS/UE.

A system for initiating PDN disconnection is provided, where the system includes an FA or an MAG and an authenticator connected to the FA or the MAG in a communicable manner, where:

the authenticator is configured to transmit PDN disconnection information to the FA or the MAG; and

the FA or the MAG is configured to receive the PDN disconnection information from the authenticator, and initiate MIP deregistration to a PDN GW corresponding to the PDN disconnection information.

A system for initiating PDN disconnection, where the system includes an MME, and an HSS and a Serving GW connected to the MME in a communicable manner, where:

the HSS is configured to transmit a Cancel Location indication to the MME, in which the Cancel Location indication carries PDN disconnection information;

the MME is configured to transmit a Delete Bearer Request message to the Serving GW, in which the Delete Bearer Request message carries a PDN GW address corresponding to the PDN disconnection information from the HSS and a HoA; and

the Serving GW is configured to initiate detachment of a corresponding GTP bearer to the corresponding PDN GW according to the PDN GW address and the HoA.

By applying the method, the device, and the system according to the embodiments of the present invention, a network side can transmit the PDN disconnection information to the FA, the MAG or the MME, and the FA, the MAG or the MME initiates the detachment of the PDN connection, so as to achieve disconnection of one or more PDNs.

### BRIEF DESCRIPTION OF THE DRAWINGS

FIG. 1 is a flow chart of a method for initiating PDN disconnection according to an embodiment of the present invention;

FIG. 2 is a flow chart of a method for initiating PDN disconnection according to an embodiment of the present invention;

FIG. 3 is a flow chart of a method for initiating PDN disconnection according to an embodiment of the present invention;

FIG. 4 is a flow chart of a method for initiating PDN disconnection according to an embodiment of the present invention;

FIG. 5 is a structural diagram of a device for initiating PDN disconnection according to an embodiment of the present invention;

FIG. 6 is a schematic structural diagram of an auxiliary device for initiating PDN disconnection according to an embodiment of the present invention;

FIG. 7 is a schematic structural diagram of an auxiliary device for initiating PDN disconnection according to an embodiment of the present invention;

FIGS. 8a and 8b are schematic structural diagrams of a system for initiating PDN disconnection according to an embodiment of the present invention; and

FIG. 9 is a schematic structural diagram of a system for initiating PDN disconnection according to an embodiment of the present invention.

### DETAILED DESCRIPTION OF THE EMBODIMENTS

To make the objectives, technical solutions, and advantages of the present invention more comprehensible, the specific embodiments of the present invention are described in further detail below with reference to the accompanying drawings.

A method according to an embodiment of the present invention is based on a network scenario below. An MS/UE establishes a PDN connection with a network. For each PDN connection, a specific MIP tunnel is established between an FA or an MAG of the network and a PDN GW/HA corresponding to each PDN, and an Internet Protocol (IP) address in each PDN is allocated to the MS/UE. The MS/UE may enjoy different services through different service providing networks corresponding to the PDNs.

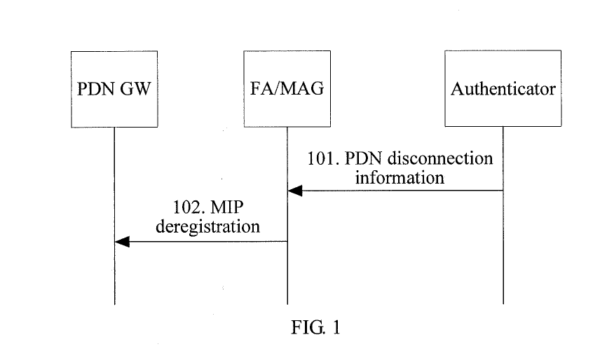

An embodiment of the present invention provides a method for initiating PDN disconnection, so as to achieve disconnection of a terminal from one or more specific PDNs. The method is shown in FIG. 1, and includes the following step.

A network side initiates disconnection of a terminal from one or more specific PDNs according to a strategy of the network side.

Step 101: An FA or an MAG receives PDN disconnection information from an authenticator.

The PDN disconnection information is PDN connection information corresponding to one or more PDN connections that the network side instructs to detach, in which the one or more PDN connections are established between the terminal (an MS/UE as shown) and PDNs, and the PDN connection information is also referred to as IP session information in a WiMAX network. The PDN disconnection information may be an Access Point Name (APN) corresponding to the PDN connection, or a PDN GW address corresponding to the PDN connection and an HoA of the MS/UE.

Step 102: The FA or the MAG initiates MIP deregistration to a PDN GW corresponding to the PDN disconnection information, so as to detach the corresponding PDN connection.

By applying the method according to the embodiment of the present invention, the FA or the MAG can receive the PDN disconnection information, and initiate detachment of the corresponding PDN connection according to the PDN disconnection information, so as to achieve initiation of PDN disconnection.

In a WiMAX system, a process that a network side initiates PDN disconnection can be initiated by an authenticator or an AAA server or an FA. In the embodiment of the present invention, a scenario that the FA initiates network exit is not involved. In exemplary embodiments below, a method for achieving disconnection of a terminal from one or more specific PDNs is further introduced respectively in a scenario that an authenticator or an AAA server initiates the PDN disconnection.

In an embodiment of the present invention, taking an authenticator initiating PDN disconnection as an example, a method for disconnecting a terminal from one or more specific PDNs is described. It should be noted that, in a scenario according to this embodiment, an FA is integrated with an Anchor Data Path Function (Anchor DPF), and are represented by an FA/Anchor DPF hereinafter.

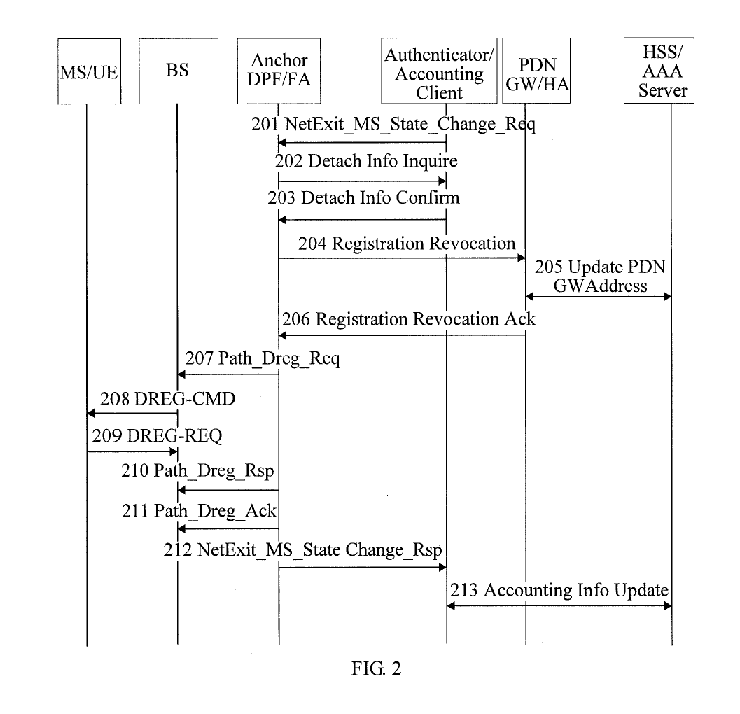

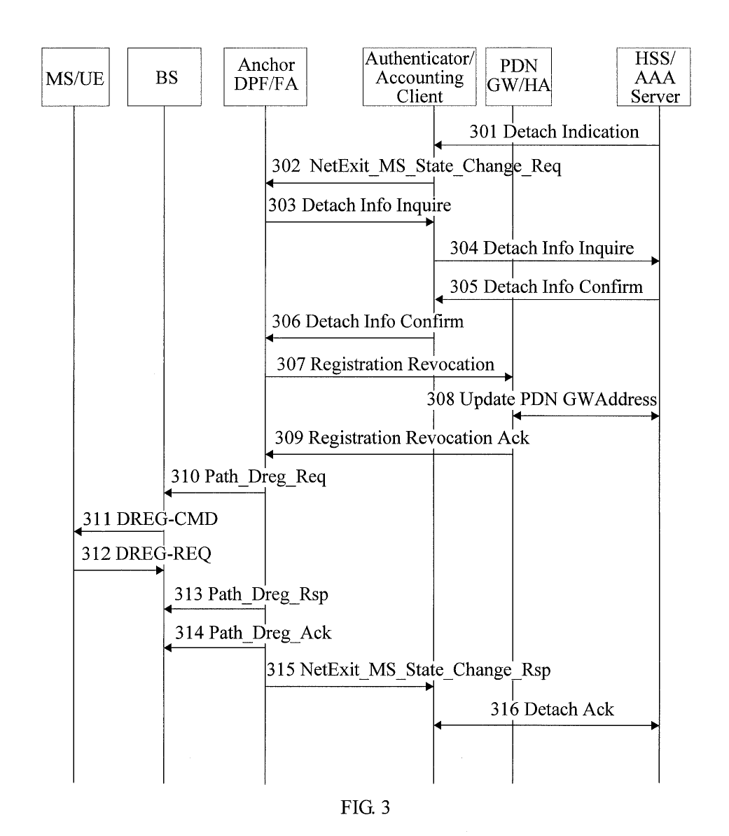

The method is shown in FIG. 2, and includes the following steps.

Step 201: An authenticator transmits a terminal network exit request NetExit_MS_State_Change_Req message to the FA/Anchor DPF, in which Action Code in the NetExitMS_State_Change_Req message is set as terminal deregistration. Optionally, the terminal network exit request NetExit_MS_State_Change_Req message may carry PDN disconnection information. The PDN disconnection information is PDN connection information corresponding to one or more PDN connections that the network side instructs to detach, the one or more PDN connections are established between the terminal (an MS/UE as shown) and the PDNs, and the PDN connection information is also referred to as IP session information in a WiMAX network. The PDN disconnection information may be an APN corresponding to the PDN connection, or a PDN GW address corresponding to the PDN connection and an HoA of the MS/UE.

It should be noted that, if the terminal network exit request NetExit_MS_State_Change_Req message does not carry the PDN disconnection information, it may be considered by default that the authenticator instructs to detach all PDN connections of the MS/UE according to a network deployment strategy. Alternatively, it may also be considered that the authenticator does not instruct to detach which PDN connection of the MS/UE, so the FA/Anchor DPF is required to inquire the PDN connections of the MS/UE to be detached, that is, step 202 to step 203 are performed.

Step 202: This step is an optional step, in which if the terminal network exit request NetExit_MS_State_Change_Req message in step 201 does not carry the PDN disconnection information, the FA/Anchor DPF transmits a Detach Info Inquire message to the authenticator to request the PDN connection information corresponding to the PDN connection to be detached. The Detach Info Inquire message may be borne by using the protocol of anR4 message.

Step 203: The authenticator returns a Detach Info Confirm message to the FA/Anchor DPF, in which the Detach Info Confirm message carries the PDN disconnection information, that is, the PDN connection information corresponding to the PDN connection to be detached. The Detach Info Confirm message may be borne by using the protocol of an R4 interface message.

Optionally, if the PDN disconnection information carried in the terminal network exit request NetExit_MS_State_Change_Req message in step 201 is an APN corresponding to one or more PDN connections that a network side instructs to detach in a current terminal network exit process, the FA/Anchor DPF may initiate step 202 to query the authenticator for the PDN GW address corresponding to the APN and the HoA, and the Detach Info Confirm message in step 203 carries the PDN GW address and the HoA.

It should be noted that, if the authenticator is integrated with the anchor DPF, message interaction between step 201 to step 203 may be omitted, or achieved by using an internal protocol of a physical network element where the authenticator and the anchor DPF are commonly located.

Step 204: The FA/Anchor DPF initiates an MIP deregistration process to a PDN GW corresponding to the PDN disconnection information according to the terminal network exit request from the authenticator. In a scenario of this embodiment, specifically, the FA/Anchor DPF transmits a Registration Revocation message to the PDN GW according to the PDN GW address, in which the Registration Revocation message includes such information as the HoA, an HA address, and a Care of Address (CoA). The HA address is the PDN GW address. In an MIP registration procedure in the WiMAX system, the FA interacts with the HA. In an architecture of the WiMAX integrated with the EPC network, the PDN GW executes the HA function.

Optionally, in step 201, if the PDN disconnection information carried in the terminal network exit request NetExit_MS_State_Change_Req message is an APN corresponding to one or more PDN connections that a network side instructs to detach in the current terminal network exit process, the FA/Anchor DPF may perform step 204 according to a correspondence between the APN and the PDN GW address as well as the HoA maintained by its own. The correspondence maintained by its own is the correspondence between the APN and the PDN GW recorded by the authenticator during PDN authorization in the process of establishing the PDN connection. When the authenticator triggers the FA to perform MIP registration, the FA can acquire the correspondence, and record the correspondence between the APN and the PDN GW address during the MIP registration.

Step 205: Perform update interaction of PDN GW address information between the PDN GW and the AAA server/HSS (the Update PDN GW address process as shown), and notify the AAA/HSS to delete a PDN GW identifier and APN information corresponding to the PDN connection to be detached.

Step 206: The PDN GW returns a Registration Revocation Ack message to the FA/Anchor DPF to confirm that the PDN connection is detached.

Step 207: The FA/Anchor DPF transmits a data path deregistration request Path_Dreg_Req message to a Base Station (BS) where the MS/UE is located, so as to initiate a data path deregistration process. The Anchor DPF detaches the data path corresponding to the PDN connection detached in step 204 to step 206. It should be noted that, establishment and maintenance of a correspondence between the PDN connection and the data path are implemented by the FA/Anchor DPF. Specifically, in the process of for establishing the PDN connection, the network side authorizes the PDN connection, and during the authorization, the FA/Anchor DPF may record the authorized PDN or corresponding APN information. After the authorization is finished, between the terminal and the network, the MIP registration and the data path establishment need to be performed for the connection between the terminal and the PDN, and the both procedures are implemented by the FA/Anchor DPF. In this case, the FA/Anchor DPF may record the corresponding PDN connection information (that is, IP session information, including, for example, the CoA and the HoA) and a data path identifier, and the FA/Anchor DPF is required to maintain information of the authorized APN or PDN, and the correspondence between the corresponding PDN connection information and the data path identifier.

Step 208: The BS transmits a DREG-CMD message to the MS/UE to trigger the MS/UE to exit the network.

Step 209: The MS/UE returns a DREG-REQ message including a data path deregistration request indication to the BS.

It should be noted that, if the PDN disconnection information in step 201 includes multiple PDN connections to be detached, a sequence of detaching the multiple PDN connections may be that step 204 to step 209 are performed for a PDN connection corresponding to the PDN disconnection information, then step 204 to step 209 are performed for another PDN connection corresponding to the PDN disconnection information, and the process is repeated till all PDN connections corresponding to the PDN disconnection information are detached. Alternatively, step 204 to step 206 are performed for a PDN connection corresponding to the PDN disconnection information, then step 207 to step 209 are performed for the PDN connection corresponding to the PDN disconnection information, at the same time, step 204 to step 206 are performed for another PDN connection corresponding to the PDN disconnection information, and the process is repeated till all PDN connections corresponding to the PDN disconnection information are detached. Definitely, as can be anticipated by persons skilled in the art, other sequences may also be used to detach all PDN connections corresponding to the PDN disconnection information.

Step 210: After detecting that the deregistration of an air interface is completed, the BS returns a data path deregistration response Path_Dreg_Rsp message to the FA/Anchor DPF, and performs the deregistration of the data path.

Step 211: The FA/Anchor DPF transmits a data path deregistration acknowledgement Path_Dreg_Ack message to the BS.

Step 212: The FA transmits a terminal network exit response NetExit_MS_State_Change_Rsp message to the authenticator, so as to confirm network exit of the MS/UE. The terminal network exit response NetExit_MS State_Change_Rsp message carries the PDN connection information corresponding to the PDN connection detached at the network side. The PDN connection information may be the APN corresponding to the PDN connection or the PDN GW address corresponding to the PDN connection and the HoA of the MS/UE.

Step 213: An Accounting Client integrated with the authenticator interacts with the AAA server/HSS in terms of accounting information, the Accounting Client notifies the PDN disconnection information in step 212 to the AAA server/HSS, and the AAA server/HSS terminates the accounting of the corresponding PDN connection or notifies other accounting servers to terminate the accounting of the corresponding PDN connection.

It should be noted that, the foregoing description of the embodiment of the present invention is applicable in a scenario that the MIP registration is performed in a Client Mobile Internet Protocol (CMIPv4) mode in the network. However, the solution in the embodiment of the present invention may be also applicable in a scenario that the MIP registration is performed in a Proxy Mobile Internet Protocol (PMIPv6) mode in the network. The differences lie in that the FA in the foregoing embodiment is replaced with an MAG, and step 204 is replaced with the solution that the MAG transmits a Proxy Binding Update (PBU) message to the PDN GW corresponding to the PDN disconnection information according to the terminal network exit request from the authenticator, so as to initiate the deregistration process. Accordingly, step 206 is replaced with the solution that the PDN GW transmits a Proxy Binding Acknowledge (PBA) message to the MAG to confirm that the PDN connection is already detached.

By applying the method according to this embodiment, the FA/Anchor DPF can acquire the PDN disconnection information of the PDN connection that the network instructs to detach, and initiate the deregistration procedure between the PDN GW corresponding to the PDN connection and the FA/Anchor DPF according to the PDN disconnection information, so as to detach the PDN connection. In addition, the data path corresponding to the PDN connection may be further detached, so as to complete the network exit of the terminal.

In an embodiment of the present invention, taking an AAA server/HSS initiating PDN disconnection as an example, a method for disconnecting a terminal from one or more specific PDNs is described. It should be noted that, in a scenario in this embodiment, an FA is integrated with an Anchor DPF, and are represented by the FA/Anchor DPF hereinafter.

Step 301: The AAA server/HSS transmits a Detach Indication to an authenticator to initiate detachment of a PDN connection. Optionally, the Detach Indication message carries PDN disconnection information. The PDN disconnection information is PDN connection information corresponding to one or more PDN connections that the network side instructs to detach, the one or more PDN connections are established between the terminal (an MS/UE as shown) and the PDN, and the PDN connection information is also referred to as IP session information in a WiMAX network. The PDN disconnection information may be an APN corresponding to the PDN connection, or a PDN GW address corresponding to the PDN connection and an HoA of the MS/UE.

It should be noted that, if the Detach Indication does not carry the PDN disconnection information, it may be considered by default that the AAA server/HSS instructs to detach all PDN connections of the MS/UE according to a network deployment strategy. Alternatively, it may also be considered that the AAA server/HSS does not instruct to detach which PDN connection of the MS/UE, so the authenticator or the FA is required to inquire the PDN connections of the MS/UE to be detached, that is, step 303 to step 306 are performed.

Step 302: The authenticator transmits a terminal network exit request NetExit_MS_State_Change_Req message to the FA/Anchor DPF, in which an Action Code in the NetExit_MS_State_Change_Req message is set as terminal deregistration. If the Detach Indication in step 301 carries the PDN disconnection information, the terminal network exit request NetExit_MS_State_Change_Req message in step 302 also carries the PDN disconnection information.

Step 303: This step is an optional step, which is performed if the terminal network exit request NetExitMS_State_Change_Req message in step 302 does not carry the PDN disconnection information, and in step 303, the FA transmits a Detach Info Inquire message to the authenticator to request the PDN connection information corresponding to the PDN connection to be detached. The Detach Info Inquire message may be borne by using the protocol of an R4 interface message.

Step 304: this step is optional, which is performed if the Detach Indication in step 301 does not carry the PDN disconnection information, and in step 304, the authenticator transmits the Detach Info Inquire message to the AAA server/HSS to request the PDN connection information corresponding to the PDN connection to be detached. The Detach Info Inquire message may be borne by using the protocol of an R3 interface message.

Step 305: This step is performed if step 304 is performed, in which the AAA server/HSS returns a Detach Info Confirm message to the authenticator, and the Detach Info Confirm message carries the PDN disconnection information, that is, the PDN connection information corresponding to the PDN connections to be detached. The Detach Info Confirm message may be borne by using the protocol of the R3 interface message.

Step 306: The authenticator returns the Detach Info Confirm message to the FA, in which the Detach Info Confirm message carries the PDN disconnection information, that is, the PDN connection information corresponding to the PDN connection to be detached. The Detach Info Confirm message may be borne by using the protocol of the R4 interface message.

It should be noted that, step 304 to step 305 may also be performed after step 301 and before step 302. If the authenticator does not transfer the PDN disconnection information received from the AAA server/HSS to the FA in step 302, the FA may acquire the PDN connection information through step 303 and step 306.

Step 307: The FA/Anchor DPF initiates a deregistration process to a PDN GW corresponding to the PDN disconnection information according to the terminal network exit request from the authenticator. In a scenario of this embodiment, specifically, the FA/Anchor DPF transmits a Registration Revocation message to the PDN GW according to the PDN GW address, in which the Registration Revocation message carries such information as an HoA, an HA address, and a CoA. The HA address is the PDN GW address. In an MIP registration process in the WiMAX system, the FA interacts with the HA. In an architecture of the WiMAX integrated with an EPC network, the PDN GW executes the HA function.

Optionally, in step 302, if the PDN disconnection information carried in the terminal network exit request NetExitMS_State_Change_Req message is an APN corresponding to one or more PDN connections that the network side instructs to detach in the current terminal network exit process, the FA/Anchor DPF may perform step 302 according to a correspondence between the APN and the PDN GW address and HoA maintained by its own. The correspondence maintained by its own is the correspondence between the APN and the PDN GW recorded by the authenticator during PDN authorization in the process of establishing the PDN connection. When the authenticator triggers the FA to perform MIP registration, the FA can acquire the correspondence, and record the correspondence between the APN and the PDN GW address during the MIP registration.

Step 308: Perform update interaction of PDN GW address information between the PDN GW and the AAA server/HSS (the Update PDN GW address process as shown), so as to notify the AAA/HSS to delete the PDN GW identifier and APN information corresponding to the PDN connection to be detached.

Step 309: The PDN GW returns a Registration Revocation Ack message to the FA/Anchor DPF, so as to confirm that the PDN connection is detached.

Step 310: The FA/Anchor DPF transmits a data path deregistration request Path_Dreg_Req message to a BS where the MS/UE is located, so as to initiate a data path deregistration process. The Anchor DPF detaches a data path corresponding to the PDN connection detached in step 307 to step 309. It should be noted that, the FA/Anchor DPF is in charge of establishment and maintenance of the correspondence between the PDN connection and the data path. Specifically, in the process of establishing the PDN connection, the network side authorizes the PDN connection, and during the authorization the FA/Anchor DPF may record the authorized PDN or corresponding APN information. After the authorization is completed, between the terminal and the network, the MIP registration and the data path establishment are performed for the connection between the terminal and the PDN, and the both procedures are implemented by the FA/Anchor DPF. In this case, the FA/Anchor DPF may record the corresponding PDN connection information (that is, IP session information, including, for example, the CoA and the HoA) and the data path identifier, and the FA/Anchor DPF is required to maintain information of the authorized APN or PDN, and the correspondence between the corresponding PDN connection information and the data path identifier.

Step 311: The BS transmits a DREG-CMD message to the MS/UE to trigger the MS/UE to exit the network.

Step 312: The MS/UE returns a DREG-REQ message including a data path deregistration request indication to the BS.

It should be noted that, if the PDN disconnection information in step 302 includes multiple PDN connections to be detached, a sequence of detaching the multiple PDN connections may be that step 307 to step 312 are performed for a PDN connection corresponding to the PDN disconnection information, then step 307 to step 312 are performed for another PDN connection corresponding to the PDN disconnection information, and the process is repeated till all PDN connections corresponding to the PDN disconnection information are detached. Alternatively, step 307 to step 309 are performed for a PDN connection corresponding to the PDN disconnection information, then step 310 to step 312 are performed for the PDN connection corresponding to the PDN disconnection information, at the same time, step 307 to step 309 are performed for another PDN connection corresponding to the PDN disconnection information, and the process is repeated till all PDN connections corresponding to the PDN disconnection information are detached. Definitely, as can be anticipated by persons skilled in the art, other sequences may be used to detach all PDN connections corresponding to the PDN disconnection information.

Step 313: After detecting that the deregistration of an air interface is completed, the BS returns a data path deregistration response Path_Dreg_Rsp message to the FA/Anchor DPF, and performs deregistration of the data path.

Step 314: The FA/Anchor DPF transmits a data path deregistration acknowledgement Path_Dreg_Ack message to the BS.

Step 315: The FA transmits a terminal network exit response NetExit_MS_State_Change_Rsp message to the authenticator, so as to confirm network exit of the MS/UE. The terminal network exit response NetExit_MS_State_Change_Rsp message carries the PDN connection information corresponding to the PDN connection detached at the network side. The PDN connection information may be the APN corresponding to the PDN connection, or the PDN GW address corresponding to the PDN connection and the HoA of the MS/UE.

Step 316: The authenticator returns a Detach Ack message to the AAA server/HSS, in which the Detach Ack message indicates disconnection information and data path information of the detached PDN.

It should be noted that, the description for the embodiment of the present invention is applicable in a scenario that the MIP registration is performed in a CMIPv4 mode in the network. However, the solution in the embodiment of the present invention may be also applicable in a scenario that the MIP registration is performed in a PMIPv6 mode in the network. The differences lie in that the FA in the embodiment is replaced with an MAG, and step 307 is replaced with the solution that the MAG transmits a PBU message to the PDN GW corresponding to the PDN disconnection information according to the terminal network exit request from the authenticator, so as to initiate the deregistration procedure. Accordingly, step 309 is replaced with the solution that the PDN GW transmits a PBA message to the MAG, so as to confirm that the PDN connection is detached.

By applying the method according to this embodiment, the FA/Anchor DPF can acquire the PDN disconnection information of the PDN connections that the network side instructs to detach, and initiate the deregistration procedure between the FA/Anchor DPF and the PDN GW corresponding to the PDN connection according to the PDN disconnection information, so as to detach the PDN connection. In addition, the data path corresponding to the PDN connection may be further detached, so as to complete network exit of the terminal.

In the foregoing two embodiments, taking the WiMAX access network system integrated with the EPC as an example, the methods for initiating PDN disconnection are described. However, in a scenario that an EPC is connected to a 3GPP access network system, problems solved by the foregoing embodiments of the present invention also exist. In the following embodiments, taking the 3GPP access network connected to an EPC system as an example, a method for initiating PDN disconnection is described.

The method according to the embodiment of the present invention is based on a network scenario described below. A PDN connection is established between a UE and a network. For each PDN connection, a specific GTP tunnel is established between an MME of the network and a PDN GW corresponding to each PDN. The UE may enjoy different services through different service providing networks corresponding to the PDNs.

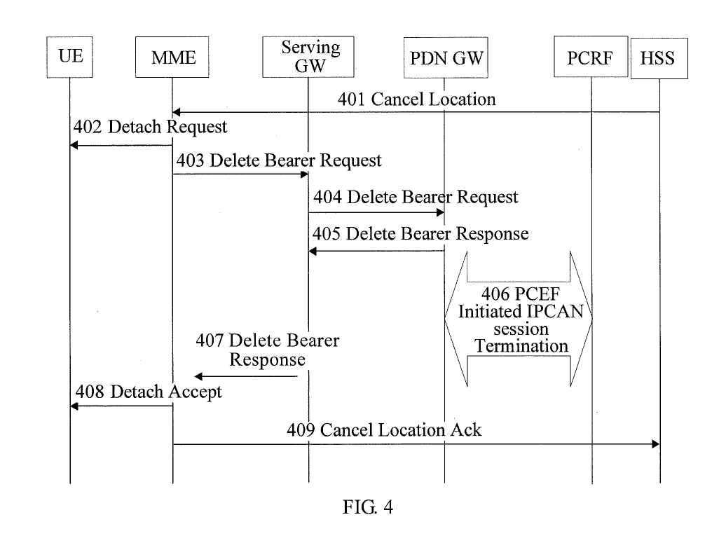

As shown in FIG. 4, the method according to the embodiment of the present invention includes specifically the following steps.

Step 401: An HSS transmits a Cancel Location indication to an MME. The Cancel Location indication carries PDN disconnection information. The PDN disconnection information is PDN connection information corresponding to one or more PDN connections that the network side instructs to detach, and the one or more PDN connections are established between a terminal (an MS/UE as shown) and a PDN. The PDN disconnection information may be an APN corresponding to the PDN connection, or a PDN GW address corresponding to the PDN connection, and an HoA of the MS/UE.

Step 402: Optionally, the MME transmits a Detach Request message to the UE, so as to indicate the UE to be disconnected from one or more PDNs.

Step 403: The MME transmits a Delete Bearer Request message to a Serving GW where the UE is located, in which the Delete Bearer Request message is used for indicating the Serving GW to detach the corresponding GTP bearer between the Serving GW and the PDN GW. If the PDN disconnection information is the APN, the MME queries the PDN GW address corresponding to the APN and an HoA according to the correspondence between the APN and the PDN GW address maintained by its own, and the Delete Bearer Request message carries the PDN GW address and the HoA; and if the PDN connection information is the PDN GW address and the HoA, the Delete Bearer Request message carries the PDN GW address and the HoA.

Step 404: The Serving GW transmits the Delete Bearer Request message to the corresponding PDN GW according to the PDN GW address and the HoA, so as to detach the corresponding GTP bearer between the Serving GW and the corresponding PDN GW.

Step 405: The PDN GW returns a Delete Bearer Response message to the Serving GW, so as to confirm that the GTP bearer is detached.

Step 406: A Policy and Charging Enforcement Function (PCEF) located on the Serving GW notifies information of a detached EPS bearer to a Policy and Charging Rules Function (PCRF).

Step 407: The Serving GW returns the Delete Bearer Response message to the MME.

Step 408: The UE returns a Detach Accept message to the MME if step 402 is performed.

Step 409: The MME confirms that the bearer is detached, and notifies the HSS to release the corresponding PDN connection information.

By applying the method according to the embodiment, the MME can acquire the PDN disconnection information of the PDN connection that the network side instructs to detach, and initiate the deregistration process between the MME and the PDN GW corresponding to the PDN connection according to the PDN disconnection information, so as to detach the PDN connection.

An embodiment of the present invention further provides a device for initiating PDN disconnection.

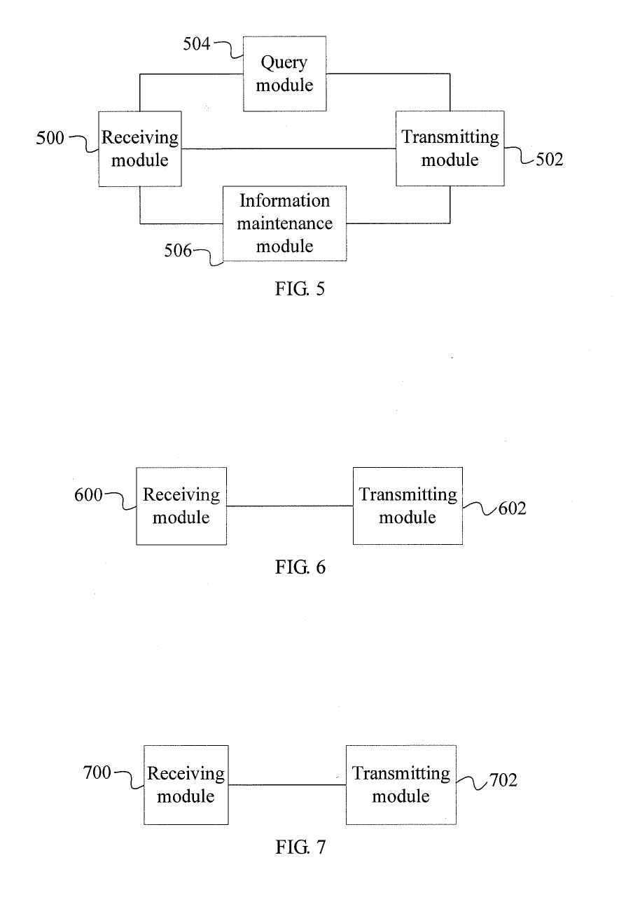

As shown in FIG. 5, the device includes a receiving module 500 and a transmitting module 502.

The receiving module 500 is configured to receive PDN disconnection information from an authenticator.

The transmitting module 502 is configured to initiate MIP deregistration to a PDN GW corresponding to the PDN disconnection information according to the PDN disconnection information from the receiving module 500.

Optionally, the device may further include a query module 504, configured to transmit a Detach Info Inquire message to the authenticator to request to resolve an APN when the PDN disconnection information received by the receiving module 500 is the APN; and receive a Detach Info Confirm message from the authenticator, in which the Detach Info Confirm message carries the PDN GW address of the PDN connection corresponding to the APN, and an HoA of a corresponding terminal.

In this case, the transmitting module 502 is further configured to initiate MIP deregistration to the corresponding PDN GW according to the PDN GW address and the HoA of the corresponding terminal from the query module 504.

Alternatively, optionally, the device further includes an information maintenance module 506, configured to acquire a correspondence between the APN and the PDN GW from the authenticator and record the correspondence between the APN and the PDN GW address in a procedure for registering a deregistered MIP tunnel.

When the PDN disconnection information received by the receiving module is the APN, the transmitting module 502 is further configured to query the PDN GW address corresponding to the APN according to the correspondence between the APN and the PDN GW address maintained by the information maintenance module 506, and initiate MIP deregistration to the PDN GW corresponding to the PDN GW address according to the PDN GW address and the HoA.

The device may be an FA or an MAG.

By applying the device according to the embodiment of the present invention, the PDN disconnection information from the authenticator can be received, and the MIP deregistration is initiated to the PDN GW corresponding to the PDN disconnection information according to the PDN disconnection information, so as to detach the corresponding PDN connection. In addition, when the PDN disconnection information from the authenticator is the APN, the device can also acquire the PDN GW address corresponding to the APN and the HoA of the corresponding terminal by querying the authenticator or according to the information of the information maintenance module, so as to initiate the MIP deregistration.

An embodiment of the present invention further provides an auxiliary device for initiating PDN disconnection. As shown in FIG. 6, the device includes a receiving module 600 and a transmitting module 602.

The receiving module 600 is configured to receive a Detach Indication or a Detach Info Confirm message from an AAA server/HSS, in which the Detach Indication or the Detach Info Confirm message carries PDN disconnection information.

The transmitting module 602 is configured to transmit the PDN disconnection information received by the receiving module 600 to an FA or an MAG.

The device is an authenticator.

By applying the device according to the embodiment of the present invention, the PDN disconnection information from the AAA server/HSS can be received, and the PDN disconnection information is transmitted to the FA or the MAG, so as to initiate disconnection of a corresponding PDN.

An embodiment of the present invention further provides an auxiliary device for initiating PDN disconnection. As shown in FIG. 7, the device includes a receiving module 700 and a transmitting module 702.

The receiving module 700 is configured to receive a Cancel Location indication from an HSS, in which the Cancel Location indication carries PDN disconnection information.

The transmitting module 702 is configured to transmit a Delete Bearer Request message to a Serving GW, in which the Delete Bearer Request message carries a PDN GW address corresponding to the PDN disconnection information received by the receiving module 700 and a HoA. A correspondence is saved in the device.

The device is an MME.

By applying the device according to the embodiment of the present invention, the PDN disconnection information from the HSS may be received, and the PDN GW address corresponding to the PDN disconnection information and the HoA are transmitted to the Serving GW, so as to indicate the Serving GW to initiate detachment of a corresponding GTP bearer to the corresponding PDN GW according to the PDN GW address and the HoA, so as to complete PDN disconnection.

An embodiment of the present invention further provides a system for initiating PDN disconnection.

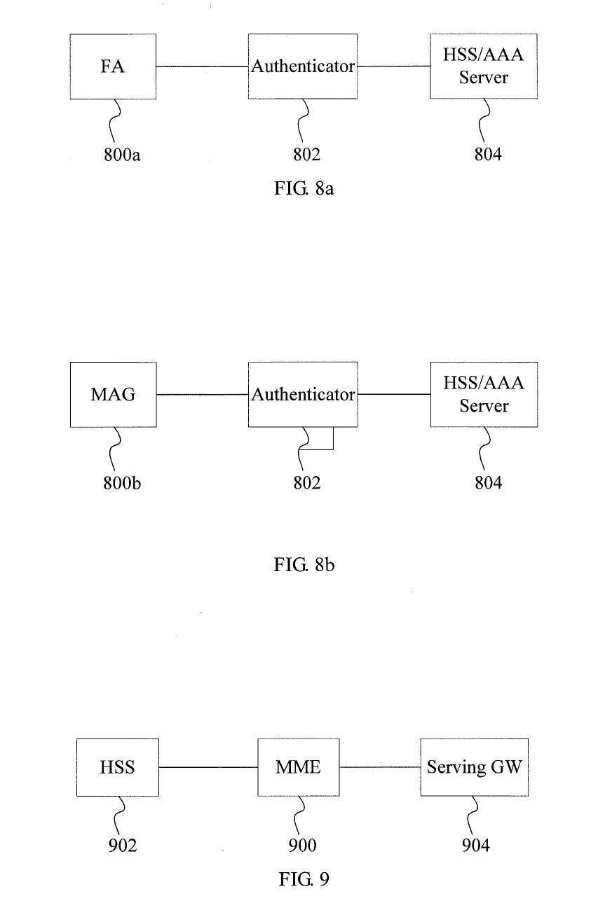

As shown in FIG. 8a, the system includes an FA 800a, and an authenticator 802 connected to the FA 800a in a communicable manner, or as shown in FIG. 8b, the system includes an MAG 800b, and an authenticator 802 connected to the MAG 800b in a communicable manner.

The authenticator 802 is configured to transmit PDN disconnection information to the FA 800a or the MAG 800b.

The FA 800a or the MAG 800b is configured to receive the PDN disconnection information from the authenticator 802, and initiate MIP deregistration to a PDN GW corresponding to the PDN disconnection information.

Optionally, if PDN disconnection is triggered by an AAA server/HSS, the system further includes an AAA server/HSS 804, configured to transmit a Detach Indication or a Detach Info Confirm message to the authenticator 802, in which the Detach Indication or the Detach Info Confirm message carries the PDN disconnection information.

The authenticator 802 is configured to transmit the PDN disconnection information from the AAA server/HSS 804 to the FA 800a or the MAG 800b.

By applying the system according to the embodiment of the present invention, the authenticator can transmit the PDN disconnection information to the FA 800a or the MAG 800b, and the FA 800a or the MAG 800b initiates MIP deregistration to a PDN GW corresponding to the PDN disconnection information according to the PDN disconnection information. Optionally, when the system includes the AAA server/HSS 804, the PDN disconnection may also be initiated by the AAA server/HSS 804, and the AAA server/HSS 804 transmits the PDN disconnection information to the authenticator 802, so as to achieve PDN disconnection.

An embodiment of the present invention further provides a system for initiating PDN disconnection. As shown in FIG. 9, the system includes an MME 900, and an HSS 902 and a Serving GW 904 which are connected to the MME 900 in a communicable manner.

The HSS 902 is configured to transmit a Cancel Location indication to the MME 900, in which the Cancel Location indication carries PDN disconnection information.

The MME 900 is configured to transmit a Delete Bearer Request message to the Serving GW 904, in which the Delete Bearer Request message carries the PDN disconnection information from the HSS 902.

The Serving GW 904 is configured to initiate detachment of a corresponding GTP bearer to a corresponding PDN GW according to the PDN disconnection information.

By applying the system according to the embodiment of the present invention, the MME 902 may receive the PDN disconnection information from the HSS 900, and transmit a PDN GW address corresponding to the PDN disconnection information and a HoA to the Serving GW 904, and the Serving GW 904 may initiate the detachment of the corresponding GTP bearer to the corresponding PDN GW according to the PDN GW address and the HoA, so as to complete PDN disconnection.

By applying the method, the device, and the system according to the embodiments of the present invention, the network side may transmit the PDN disconnection information to the FA or the MAG or the MME, and the FA or the MAG or the MME initiates the detachment of a PDN connection, so as to achieve disconnection of one or more PDNs. In addition, in a WiMAX access network system, a data path corresponding to the PDN connection may be further detached, so as to complete the network exit of the terminal.

Through the above description of the implementation, it is clear to persons skilled in the art that the present invention may be implemented through software plus a necessary universal hardware platform, or definitely through hardware. Based on this, the technical solutions of the present invention or the part contributing to the prior art may be embodied in the form of a software product. The software product may be stored in a readable storage medium such as a hard disk or an optical disk) and include several instructions used to instruct computer equipment (for example, a personal computer, a server, or network equipment) to perform the methods according to the embodiments of the present invention.

The above embodiments are merely provided for describing the technical solutions of the present invention, but not intended to limit the present invention. It should be understood by persons of ordinary skill in the art that although the present invention has been described in detail with reference to the embodiments, modifications can be made to the technical solutions described in the embodiments, or equivalent replacements can be made to some technical features in the technical solutions, as long as such modifications or replacements do not depart from the spirit and scope of the present invention.

What is claimed is:

1. A method for initiating Packet Data Network (PDN) disconnection, comprising:
receiving, by a Foreign Agent (FA) or a Mobile Access Gateway (MAG), PDN disconnection information from an authenticator; and
initiating Mobile Internet Protocol (MIP) deregistration to a PDN Gateway (PDN GW) corresponding to the PDN disconnection information.

2. The method according to claim 1, wherein the receiving, by the FA or the MAG, the PDN disconnection information from the authenticator comprises:
receiving, by the FA or the MAG, a terminal network exit request from the authenticator, wherein the terminal network exit request carries the PDN disconnection information.

3. The method according to claim 1, wherein the receiving, by the FA or the MAG, the PDN disconnection information from the authenticator comprises:
receiving, by the FA or the MAG, a Detach Info Confirm message from the authenticator, wherein the Detach Info Confirm message carries the PDN disconnection information; and
before the receiving, the method further comprises:
receiving, by the FA or the MAG, the terminal network exit request from the authenticator, and transmitting a Detach Info Inquire message to the authenticator.

4. The method according to claim 2, wherein before the receiving, by the FA or the MAG, the terminal network exit request from the authenticator, the method further comprises:
receiving, by the authenticator, a Detach Indication from an Authentication, Authorization, and Accounting (AAA) server/Home Subscriber Server (HSS), wherein the Detach Indication carries the PDN disconnection information;
or
receiving, by the authenticator, the Detach Indication from the AAA server/HSS, transmitting the Detach Info Inquire message to the AAA server/HSS, and receiving the Detach Info Confirm message from the AAA server/HSS, wherein the Detach Info Confirm message carries the PDN disconnection information.

5. The method according to claim 3, wherein before the receiving, by the FA or the MAG the terminal network exit request from the authenticator, the method further comprises:
receiving, by the authenticator, the Detach Indication from the AAA server/HSS; and
before the receiving, by the FA or the MAC; the Detach Info Confirm message from the authenticator, the method further comprises: transmitting, by the authenticator, the Detach Info Inquire message to the AAA server/HSS, and receiving the Detach Info Confirm message from the AAA server/HSS, wherein the Detach Info Confirm message carries the PDN disconnection information.

6. The method according to claim 1, wherein
the PDN disconnection information is PDN connection information corresponding to one or more PDN connections that a network side instructs to detach, and comprises an Access Point Name (APN) corresponding to the PDN connection, or a PDN GW address corresponding to the PDN connection and a Home Address (HoA) of a Mobile Station (MS)/User Equipment (UE).

7. The method according to claim 6, wherein if the PDN disconnection information is the APN, before the initiating, by the FA or the MAG the MIP deregistration to the PDN GW corresponding to the PDN disconnection information, the method further comprises:
transmitting, by the FA or the MAG, the Detach Info Inquire message to the authenticator, so as to request the PDN GW address of corresponding to the PDN connection corresponding to the APN, and the HoA; and
receiving the Detach Info Confirm message from the authenticator, wherein the Detach Info Confirm message carries the PDN GW address and the HoA; and
the initiating, by the FA or the MAG the MIP deregistration to the PDN GW corresponding to the PDN disconnection information comprises: initiating MIP deregistration to the PDN GW corresponding to the PDN GW address according to the PDN GW address and the HoA.

8. The method according to claim 6, wherein if the PDN disconnection information is the APN, the method comprises:
querying, by the FA or the MAG, the PDN GW address corresponding to the APN according to a correspondence between the APN and the PDN GW address maintained by the FA or the MAG and initiating MIP deregistration to the PDN GW corresponding to the PDN GW address according to the PDN GW address and the HoA.

9. The method according to claim 6, further comprising:
notifying, by the PDN GW, the AAA server/HSS to delete an identifier of the PDN GW and corresponding APN information.

10. The method according to claim 9, further comprising:
receiving, by the FA or the MAG a message from the PDN GW confirming that the PDN connection is detached; and
transmitting, by an Anchor Data Path Function (Anchor DPF) integrated with the FA or the MAG, a data path deregistration request to a Base Station (BS), so as to detach a data path corresponding to the PDN connection.

11. A method for initiating Packet Data Network (PDN) disconnection, comprising:
receiving, by a Mobile Management Entity (MME), a Cancel Location indication from a Home Subscriber Server (HSS), wherein the Cancel Location indication carries PDN disconnection information; and
transmitting a Delete Bearer Request message to a Serving Gateway (Serving GW), wherein the Delete Bearer Request message carries a PDN Gateway (PDN GW) address corresponding to the PDN disconnection information and a Home Address (HoA) of a Mobile Station (MS)/User Equipment (UE), so as to enable the Serving GW to initiate detachment of a corresponding General Packet Radio Service (GPRS) Tunneling Protocol (GTP) bearer to the corresponding PDN GW according to the PDN GW address and the HoA.

12. The method according to claim 11, wherein the PDN disconnection information is PDN connection information corresponding to one or more PDN connections that a network side instructs to detach, and is an Access Point Name (APN) corresponding to the PDN connection or the PDN GW address corresponding to the PDN connection and the HoA.

13. A device for initiating Packet Data Network (PDN) disconnection, comprising:
a receiving module, configured to receive PDN disconnection information from an authenticator; and
a transmitting module, configured to initiate Mobile Internet Protocol (MIP) deregistration to a PDN Gateway (PDN GW) corresponding to the PDN disconnection information according to the PDN disconnection information from the receiving module.

14. The device according to claim 13, further comprising:
a query module, configured to transmit a Detach Info Inquire message to the authenticator to request to resolve an Access Point Name (APN) when the PDN disconnection information received by the receiving module is the APN; and
receive a Detach Info Confirm message from the authenticator, wherein the Detach Info Confirm message carries a PDN GW address of the PDN connection corresponding to the APN, and a Home Address (HoA) of a Mobile Station (MS)/User Equipment (UE),
wherein the transmitting module is further configured to initiate MIP deregistration to the corresponding PDN GW according to the PDN GW address and a HoA from the query module.

15. The device according to claim 13, further comprising:
an information maintenance module, configured to acquire a correspondence between the APN and the PDN GW from the authenticator and record the correspondence between the APN and the PDN GW address in a procedure for registering a deregistered MIP tunnel,
wherein when the PDN disconnection information received by the receiving module is the APN, the transmitting module is further configured to query the PDN GW address corresponding to the APN according to the correspondence between the APN and the PDN GW address maintained by the information maintenance module, and initiate MIP deregistration to the PDN GW corresponding to the PDN GW address according to the PDN GW address and the HoA.

16. An auxiliary device for initiating Packet Data Network (PDN) disconnection, comprising:
a receiving module, configured to receive a Detach Indication or a Detach Info Confirm message from an Authentication, Authorization, and Accounting (AAA) server/Home Subscriber Server (HSS), wherein the Detach Indication or the Detach Info Confirm message carries PDN disconnection information; and
a transmitting module, configured to transmit the PDN disconnection information received by the receiving module to a Foreign Agent (FA) or a Mobile Access Gateway (MAG).

17. An auxiliary device for initiating Packet Data Network (PDN) disconnection, comprising:
a receiving module, configured to receive a Cancel Location indication from a Home Subscriber Server (HSS), wherein the Cancel Location indication carries PDN disconnection information; and
a transmitting module, configured to transmit a Delete Bearer Request message to a Serving Gateway (Serving GW), wherein the Delete Bearer Request message carries a PDN Gateway (PDN GW) address corresponding to the PDN disconnection information received by the receiving module, and a Home Address (HoA) of a Mobile Station (MS)/User Equipment (UE).

18. A system for initiating Packet Data Network (PDN) disconnection, comprising a Foreign Agent (FA) or a Mobile Access Gateway (MAG), and an authenticator connected to the FA or the MAG in a communicable manner, wherein
the authenticator is configured to transmit PDN disconnection information to the FA or the MAG; and
the FA or the MAG is configured to receive the PDN disconnection information from the authenticator, and initiate Mobile Internet Protocol (MIP) deregistration to a PDN Gateway (PDN GW) corresponding to the PDN disconnection information.

19. The system according to claim 18, further comprising an Authentication, Authorization, and Accounting (AAA) server/Home Subscriber Server (HSS) connected to the authenticator in a communicable manner, wherein
the AAA server/HSS is configured to transmit a Detach Indication or a Detach Info Confirm message to the authenticator, wherein the Detach Indication or the Detach Info Confirm message carries the PDN disconnection information; and
the authenticator is configured to transmit the PDN disconnection information from the AAA server/HSS to the FA or the MAG.

20. A system for initiating Packet Data Network (PDN) disconnection, comprising a Mobile Management Entity (MME), and a Home Subscriber Server (HSS) and a Serving Gateway (Serving GW) connected to the MME in a communicable manner, wherein
the HSS is configured to transmit a Cancel Location indication to the MME, wherein the Cancel Location indication carries PDN disconnection information;
the MME is configured to transmit a Delete Bearer Request message to the Serving GW, wherein the Delete Bearer Request message carries a PDN Gateway (PDN GW) address corresponding to the PDN disconnection information from the HSS, and a Home Address (HoA) of a Mobile Station (MS)/User Equipment (UE); and
the Serving GW is configured to initiate detachment of a corresponding General Packet Radio Service (GPRS) Tunneling Protocol (GTP) bearer to the corresponding PDN GW according to the PDN GW address and the HoA.
